(19) United States
(12) Patent Application Publication
(10) Pub. No.: US 2010/0258584 A1
(43) Pub. Date: Oct. 14, 2010

(54) System for transient storage and dispensing of solid particulate materials and its method of use

(76) Inventor: Richard Shaw, Trumbull, CT (US)

Correspondence Address: MICHAEL P. ARONSON, MP&G ARONSON INC, 2 MANDARIN LANE, WEST NYACK, NY, 10994, US

(21) Appl. No.: 12/386,086

(22) Filed: Apr. 14, 2009

(51) Int. Cl. B67D 5/00

(52) U.S. Cl. 222/1; 222/166

(57) ABSTRACT

A dispensing system and method of use for the transient storage and dispensing of solid particulate materials is described. The dispensing system includes: a container comprising front and back walls and two side walls, a bottom, a pour spout affixed to the front wall, a container support tube joined to the side walls of the container; a container support stand comprising a base affixed to two upright members adjacent to the side walls of the container; a support rod which passes through the bag support tube and rotatably connects the container to the upright members of the container support stand; and a locking member which when engaged prevents rotation of the container; wherein the container can rotate at least about 180 degrees from the vertical when the locking member is not engaged.

### FIELD OF INVENTION

The present invention relates to a dispensing system and method of use for the transient storage and convenient dispensing of solid particulate materials, especially solid materials purchased in bulk and used in the home and for its method of use.

### BACKGROUND OF INVENTION

There are a variety of applications for which consumers purchase solid materials in bulk generally because of a combination of economy (lower cost per unit weight) and convenience (lower purchase frequency). Such materials include but are not limited to wood pellets and other combustible materials for stoves and heating devices, cat liter, animal feeds, bird seed, deicing solids (e.g. rock salt), planting ingredients (e.g., vermiculite) and lawn and shrub care compositions.

A common problem encountered in the use of bulk solids is the transport and dispensing of the solids from where the solids are stored to the site where the solids are actually used. Generally bulk solids are sold in bags weighing 40 pounds (about 18 kilograms) or more making them difficult to carry and to dispense their contents at the application site or into smaller containers used to transport the solid particulate material to the application site. Furthermore, such bags are often unstable, difficult to completely reseal, non-waterproof, and not aesthetic.

Thus, storing and dispensing bulk solids in the bag or container in which they have been purchased is less than ideal in terms of convenience and in terms of the locations where such bags can be stored. Nevertheless, to the inventor's knowledge no real alternative is available to consumers who utilize solids in bulk.

### SUMMARY OF THE INVENTION

The inventor has discovered a design for a system for the transient storage and dispensing of solid particulate materials which is especially useful for solid materials which are purchased in bulk. Specifically, the dispensing system includes: a container comprising front and back walls and two side walls, a bottom, a pour spout affixed to the front wall, a container support tube joined to the side walls of the container; a container support stand comprising a base affixed to two upright members adjacent to the side walls of the container; a support rod which passes through the container support tube and rotatably connects the container to the upright members of the container support stand; and a locking member which when engaged prevents rotation of the container; wherein the container can rotate at least 180 degrees from the vertical when the locking member is not engaged.

In another embodiment of the invention the system includes a concave element located at a junction of the front wall and the bottom of the container. This element reduces the retention of solid residue and allows the container to be fully emptied.

In another embodiment of the invention the storage and dispensing system includes a container cover which fits over an open top of the container and optionally extends over the pour spout.

In still another embodiment, the storage and dispensing system of the invention includes a pour spout cover which is preferably affixed either to a container cover or to one or more container walls by means of a hinge or hinges which permit the pour spout cover to open when the container is rotated and the contents dispensed.

A further embodiment of the current invention is a method for the transient storage and dispensing of solid particulate materials utilizing the dispensing system outlined above which is especially useful in storing and dispensing solid materials which are purchased in bulk. The method includes the steps of:

i) placing a bag containing solid particulate material into the container of a dispensing system comprising: a container comprising front and back walls and two side walls, a bottom, a pour spout affixed to the front wall, a container support tube joined to the side walls of the container; a container support stand comprising a base affixed to two upright members adjacent to the side walls of the container; a support rod which passes through the bag support tube and rotatably connects the container to the upright members of the container support stand; and a locking member which when engaged prevents rotation of the container; wherein the container can rotate at least 180 degrees from the vertical when the locking member is not engaged; and wherein the dispensing system is in a locked position when the bag is placed in the container; and wherein the bag rests against and is supported by the container support tube;

ii) creating an opening in the bag near to a lower portion of the bag, said opening being sufficiently large to allow the solid particulate material to flow out from the bag and into the container;

iii) gradually removing the bag from the container to empty its contents into the container;

iv) disengaging the locking member and rotating the container to dispense the particulate material from the container into a second container provided by a user of the dispensing system.

These and other variations of the inventive storage and dispensing system will become clear from the description of the invention described more fully in the following detailed description which is meant to be read in conjunction with the accompanying drawings.

### BRIEF DESCRIPTION OF DRAWING

Various features of the storage and dispensing system of the invention will now be described in more detail with reference to the following drawings which should be viewed in combination with the detailed written description:

FIG. 1 is a side perspective view of the storage and dispensing system in the “locked” mode;

FIG. 2 is a side perspective view of the storage and dispensing system in the “rotating” mode;

FIG. 3 is a top perspective view of the storage and dispensing system showing the container support tube 14 and optional locking tube 50;

FIG. 4 is a cross-sectional side view of the storage and dispensing system of FIG. 1 along a vertical plane passing through the medial line A-A′ and a partial (lower section only) medial cross sectional view of an alternative embodiment of a container;

FIG. 5 is a perspective view of one embodiment of the container support stand of the storage and dispensing system shown in FIG. 1.

FIG. 6 provides perspective views of an alternative embodiment of the container support stand that can be employed in the storage and dispensing system of the invention;

FIG. 7 is a perspective view of the storage and dispensing system with optional container cover and hinged pour spout cover;

FIG. 8 is a perspective view illustrating the filling of the container with a bag containing solid particulate material shown by dashed lines (bag is not part of inventive dispensing system but is a part of the inventive method).

### DETAILED DESCRIPTION OF THE INVENTION

Except in the operating and comparative examples, or where otherwise explicitly indicated, all numbers in this description which indicate dimensions or amounts of material are to be understood as modified by the word “about” unless otherwise specified.

For the avoidance of doubt the word “comprising” is intended to mean “including” but not necessarily “consisting of” or “composed of.” In other words, the listed components, steps or options need not be exhaustive.

Dispensing System

The invention first relates to the design for a system for the transient storage and dispensing of solid particulate materials which is especially useful in storing and dispensing solid materials which are purchased in bulk especially those bulk materials sold in bags. The term solid particulate material is used in a general sense to encompass granules, pellets, powders (usually coarse powders), chips, flakes and the like. The system of the invention can be of a range of sizes and dimensions to hold various weight and volumes of various solid particulate materials of different densities especially in amounts ranging from about 25 lbs to about 125 lbs. The components of the system can be made of various materials so long as they are sufficiently strong and durable to support the require weights and provide a long working life to the system. Examples of suitable materials include metals, plastics, wood and various combinations of such materials.

Referring now to the drawings in detail, wherein like numerals indicate the same elements throughout the views, there are illustrated preferred embodiments of the storage and dispensing system of the present invention.

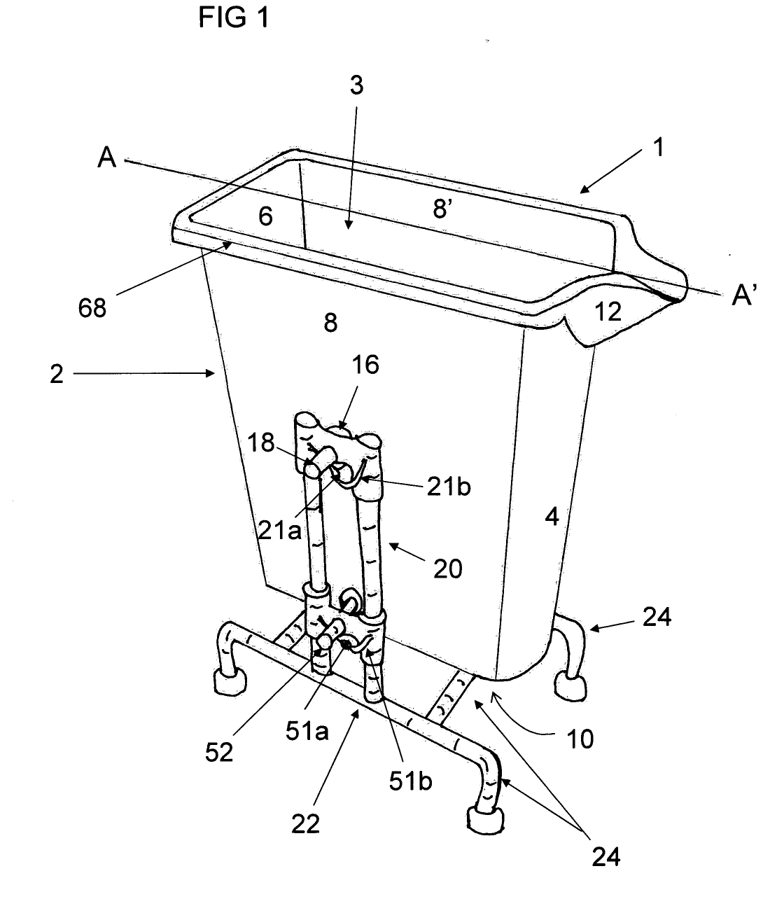

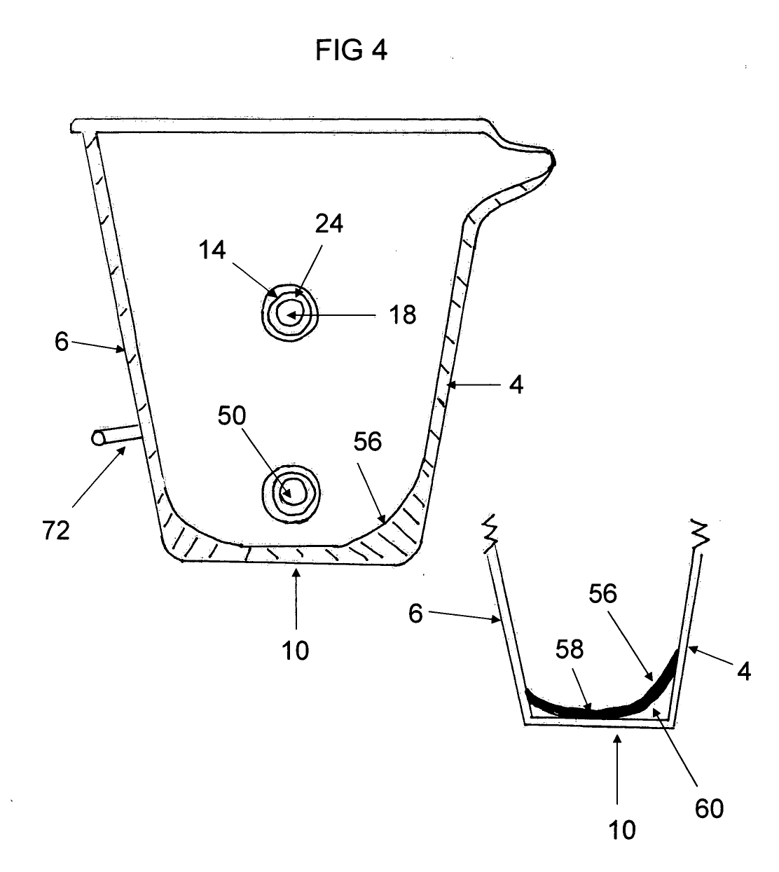

With reference to FIG. 1, the first component of the dispensing system 1 is a container 2 having in this embodiment an open top 3 comprising front 4 and back 6 walls and two side walls 8, 8′, a bottom 10, a pour spout 12 affixed to the front wall 4. Preferably one or more of the front wall 4, back wall 6 and side walls 8, 8′ are inclined inwardly as shown in FIGS. 1 and 4 such that a cross sectional area measured in a horizontal plane at the top of the container (essentially the width multiplied by the length of the container at its top) which is greater than an apparent cross sectional area of the bottom of the container (essentially the width of the container at the bottom multiplied by the length of the container at the bottom). That is, the container becomes progressively narrower or tapers towards the bottom. Preferably both the front wall 4 and back wall 6 are inclined inwardly. Another suitable arrangement is for all the walls of the container to be inclined inwardly.

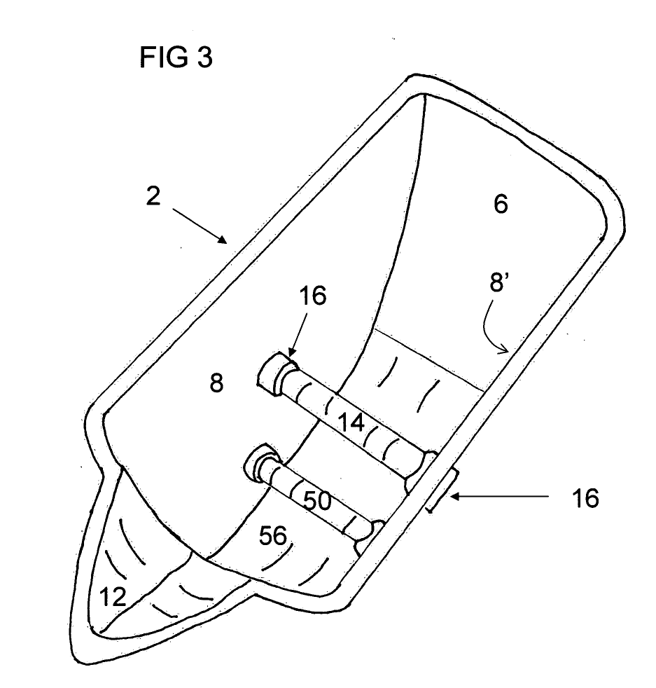

The container 2 also includes a hollow container support tube 14 best seen in FIG. 3, which is joined by a container support tube joining means 16 to the side walls 8, 8′ of the container 2. The container support tube joining means 16 can be a press fit bushing, a threaded coupling, a molded or welded joint or any other suitable joining means to securely fix the container support tube 14 to the side walls 8, 8′ of the container 2.

The container support tube 14 serves two functions. Firstly, the container support tube 14 provides a channel which accommodates a container support rod 18 which joins the container 2 to two upright members 20 of the container support stand 22. The container support rod 18 and container support tube 14 assembly thereby supports the weight of the container 2 and contents and allows the container 2 to freely rotate, preferably by at least about 180 degrees from the vertical, in a plane orthogonal to the container support rod 18 and container support tube 14. Thus, the container support rod 18 passes through the container support tube 14 and rotatably connects the container 2 to the upright members of the container support stand 20.

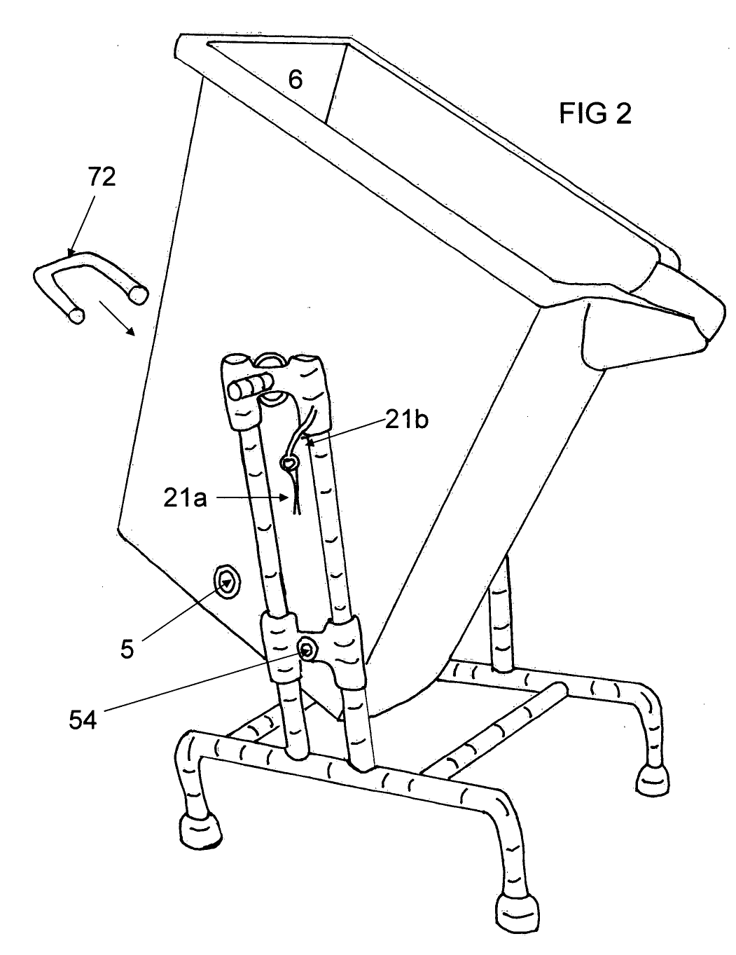

For purpose of cleaning the container 2, it is convenient that the container support rod 18 is removable. A useful optional component is a fastening means to lock the container support rod 18 in place. The container support rod fastening means can be a simple dowel 21A attached to one of the upright members of the container support stand by means of a chain or wire 21B as shown in FIGS. 1 and 2. Alternatively, other types of fastening means can be employed such as a cotter pin, locking nut or fixed chain for example.

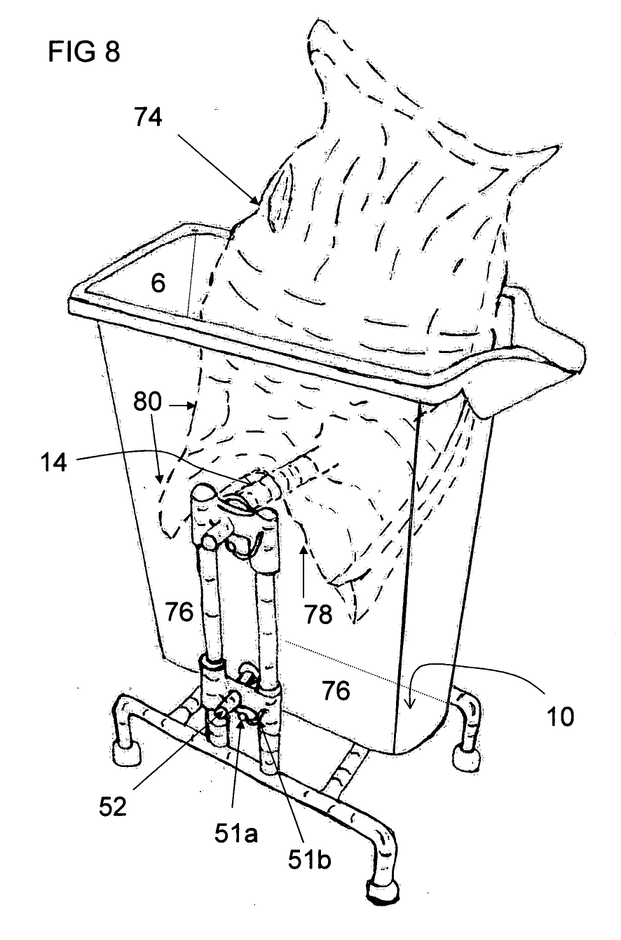

A second function of the container support tube 14 is to provide a platform or “stop” which supports the weight of a bag containing the solid material (e.g., a bag of wood pellets) during the filling operation in which solid particulate material in loaded into the container 2 (see FIG. 8 and the discussion of the METHOD OF USE of the dispensing system given below).

It is preferable to join the container support rod 18 to the container support tube 14 by means or a bearing 24 (FIG. 4) which can be a simple friction bearing or for example, a roller or ball bearing. The bearing 24 reduces wobble and provides further rotational control and stability to the dispensing system 1.

Although in the embodiments shown in FIG. 1-9, the container support tube 16 has a circular cross section, the container support rod 18 and container support tube 14 can have any suitable cross-section profile, e.g., elliptical.

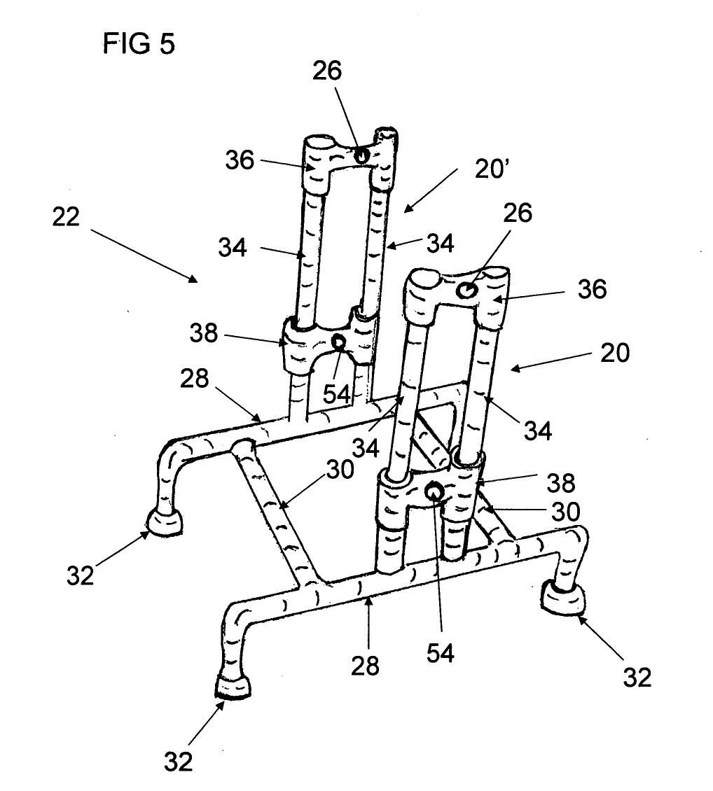

The container support rod 18 couples the container 2 to the container support stand 22. One embodiment of the container support stand 22 shown in more detail in FIG. 5 includes a base 24 affixed to two upright members 20 which accommodate the container support rod via, for example channels 26. In the embodiments show in FIGS. 1, 2, 5, and 7-8, the part of the container support stand 22 has a tubular construction in which the base 24 is comprised of two side members 28 connected by transverse base members 30. By the term “tubular construction” is meant that the parts have the external appearance of tubes. However, the various “tubes” can be either hollow or solid or a combination of hollow and solid “tubes”. The side members 28 end in optional rubber feed 32. The upright members 20 are of an analogous tubular construction each upright member 20 including two vertical tubes 34 joined by an upper transverse member 36 and a lower transverse member 38.

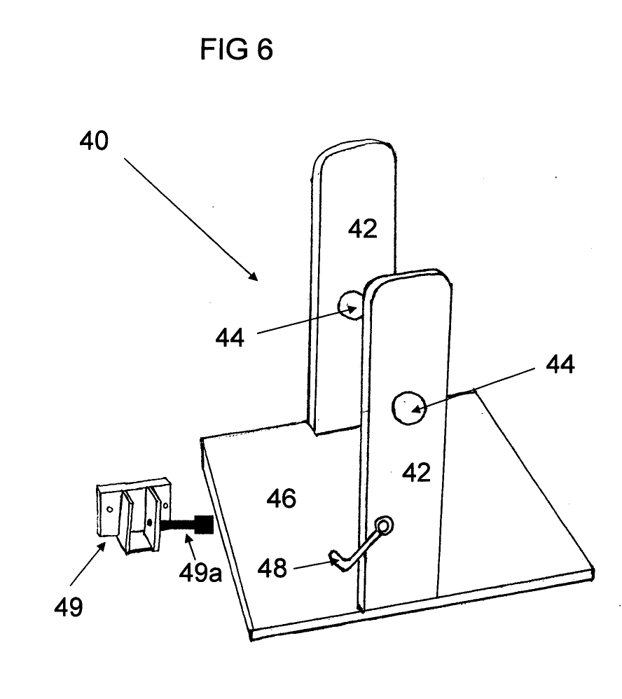

Although in the embodiments shown in FIGS. 1, 2, 5, and 7-8 the container support stand is of a tubular construction, various alternative designs can be employed as long as the container support stand provides adequate support, stability and durability and further allows the container 2 to freely rotate (when the dispensing system is in the “rotating mode”), preferably to at least about 180 degrees from vertical, in order to conveniently dispense the solid particulate material from the container. One such alternative design is the container support stand 40 shown in FIG. 6 which is of a predominantly rectilinear construction comprising two solid upright members 42 each including a container rod support channel 44, said upright member being affixed to a solid base 46. One of the upright members 42 also includes one embodiment of a locking member 48 whose function is discussed below

Because the hollow container support tube 14 and container support rod 18, allow free rotation of the container 2, the dispensing system 1 of the invention also includes a locking mechanism which immobilizes or locks the container (i.e., prevents rotation of the container 2) so that the container can be conveniently filled with the solid particulate material and the solid contents stored in the container in a stable state until dispensing is desired. Generally, the locking mechanism or locking means locks or immobilized the container 2 in a vertical or upright position (“locked position”) during filling and storage as is shown in FIGS. 1 and 8, although off-vertical locking positions may be suitable for some applications.

A variety of locking means can be employed. One convenient locking means which provides particular stability to the dispensing system is shown in the embodiments depicted in FIGS. 1, 7 and 8 and comprises a locking tube 50 (FIGS. 3 and 4) which is fixed to both side walls 8, 8′ of the container and a removable locking rod 52 (FIG. 1) which passes through the locking tube 50 and a channel 54 (FIG. 5) in at least one of the upright members 20 (or 42) of the container support stand 22 (or 40). When the locking rod 52 is in place (e.g., FIG. 8) the container 2 is immobilized and will not tip thus allowing hands free filling of the container (see below) and stable storage until dispensing is desired.

An alternative locking member is a latching assembly comprising a rotatable latch 48 fastened to at least one of the upright members, e.g., 42 which mates with a latch receptacle 49 (a “U-shaped channel” such as shown in FIG. 6) and locking member 49a, said lock receptacle being suitably fastened to a side wall 8 of the container 2. Other types of locking mechanisms can also be employed

Before dispensing, the locking rod 52 is removed (or latch 48 is disengaged from the latch receptacle 49) so that the container can be rotated, as shown in FIG. 2 to dispense the contents, into any desired container chosen by the user (not shown) to transport the particulate material to the location where the solids are it is to be used or dispensed directly at the application site.

To prevent inadvertent removal of the locking rod 52 it is useful to incorporate a means to secure the locking rod 52 to at least one of the upright members 20 of the container support stand 22 to keep it in place until its removal is desired. The locking rod securing means can be a simple dowel 51A attached to one of the upright members 20 of the container support stand 22 by means of a chain or wire 51B as shown for example, in FIG. 1. Alternatively, other types of fastening means can be employed such as a cotter pin, locking nut or fixed chain for example. Similar securing means can obviously employed for latches and other locking means, e.g., the pin shown as element 49a in the alternative locking mechanism shown in FIG. 6.

A useful optional feature to incorporate into the design of the dispensing system described herein is a concave surface 56 located at least at the interior junction of the front wall 4 and the bottom of the container 10 as is shown in FIG. 4. It has been found that such a concave transition region 56 improves the outflow of solid particulate material and also reduces the retention of solid residue when the container is emptied which would otherwise tend to collect in corners and along junction lines 60.

The concave surface 56 can be an integral part of the interior surface of one or both the front wall and bottom of the container which is especially convenient when the container 2 is constructed as a single molded unit, e.g., molded plastic.

As shown in the insert in FIG. 4 in partial (lower portion only) cross-sectional view, the concave surface 56 can be formed by a separate bottom insert 58 which at least spans the lower interior portion of the front wall 4 and the interior portion of the bottom of the container 10 and at least covers a junction line 60 formed between the front wall 4 and bottom 10. This separate bottom insert 56 can for example form a “false bottom” which fits snugly inside the container and is glued or otherwise fastened to the container 2 and provides a concaved transition region 56.

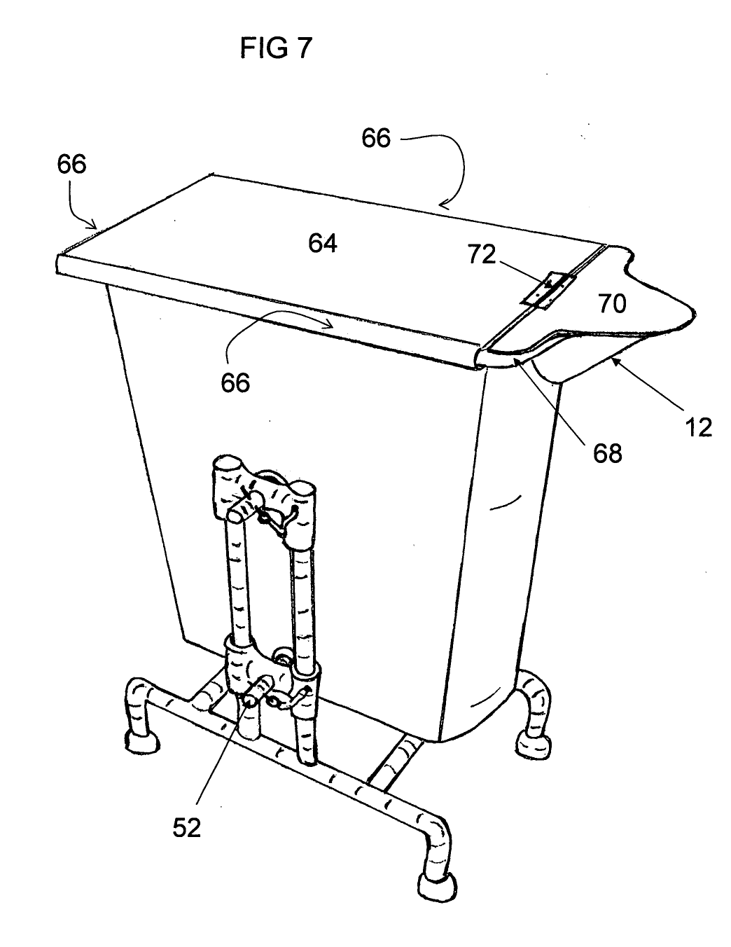

The dispensing system can also include a cover to protect the contents of the container from the environment (e.g., when the container is employed outside) and also as a safety feature. One exemplary embodiment of a cover is the container cover 64 shown in FIG. 7 which fits over the open top of the container 2 and optionally extends over the pour spout 12. The exemplary container cover 64 shown in the embodiment in FIG. 7 includes a peripheral flange 66 which extends outwardly and downwardly around the back and two sides of the cover 64. The peripheral flange 66 mates with an optional rim 68 of the container 2, said rim extending around the perimeter a the top of the front 4, side 8, 8′ and back 6 of the container 2 (see FIG. 1). This cover flange 66 serves to secure the cover 64 to the container 2. The cover 64 can either be a separate piece or can be attached to the container by, for example, a hinge or hinges (embodiment not shown). Other securing means besides the flange/rim arrangement shown in FIG. 7 can obviously be employed to secure the cover to the container, e.g., a press fitting or landings.

The dispensing container according to the invention can further comprise a pour spout cover 70 which is affixed to the container cover. This pour spout cover 70 can be affixed to a container cover 64 as show in FIG. 7 by means of a hinge. Alternatively, the pour spout cover can be affixed to one or more of the container walls also by means of a hinge or hinges (not shown). In either case, this hinged arrangement permits the pour spout cover 70 to open when the container 2 is rotated (“unlocked position” of the locking mechanism or “dispensing mode”) to dispense the contents of the container 2. This feature not only protects the material inside the container but also helps reduce spill-over of the solid particulate material during dispensing into, for example, a smaller container used to transport the material to the application site.

A further useful optional feature for the dispensing system is a gripping means which facilitates rotating the container and allows more control during dispensing. One suitable gripping means is a handle 72 attached to the back wall 6 of the container 2 as shown in the insert in FIG. 2 and in cross-section of in FIG. 7. Of coarse other gripping means can be utilized and their affixing point need not be on the back wall.

Other optional features can be incorporated into the dispensing system described herein including additional tubes, bars, or platforms (fastened to the container walls which provide additional support for heavy bags of particulate materials during the filling operation as described below.

For purposes of illustration and not intended to limit the scope of the invention, the approximate dimensions of an exemplary dispensing system as depicted in FIG. 7 are:

| | | |
|---|---|---|
| Top of container cover 64: | 11″ × 20″ | (inches) |
| Bottom of Container 10: | 8.5″ × 17″ | |
| Bottom of container support | 33″ | |
| stand 22 to top of cover 64: | | |
| Pour spout cover 70: | 5.25″ × 10″ | |
| Container support base 22: | 13″ × 20″ | |

Method of Use

A further embodiment of the current invention is a method for the transient storage and dispensing of solid particulate materials utilizing the dispensing system outlined above which is especially useful in storing and dispensing solid materials which are purchased in bulk. The method includes the following steps:

i) The first step in the method is for the user to place a bag containing the solid particulate material (e.g., a 40 lb bag of wood pellets used in wood stoves) into the container 2 of the dispensing system as described and set forth above. One of the advantages of dispensing system of the current invention can be understood from a consideration of FIG. 8 which schematically depicts the situation after a bag 74 containing the particulate material (shown in dashed lines because it is not part of the dispensing system but part of the method of use) is placed into the container 2 of the dispensing system 1. In the current design, the bottom surface 78 of the bag 74 rests against the container support tube 14 and thus the weight of the bag 74 is supported by the container support tube 14 leaving an empty volume 76 below the bottom surface of the bag 76 and the interior surface of the container bottom 10, said volume 76 accommodating at least a portion of the solid particulate material when the bag 74 is opened (step ii) near its bottom 78 such as along the surface 80.

ii) The next step of the method is to create an opening in the bag so positioned in the container (step i), said opening being made near to a lower portion of the bag (e.g., at surface 80) that is sufficiently large to allow the solid particulate material to flow out from the bag and enter the container. The opening can be created by simply cutting the bag near its bottom with a knife or box cutter to form a slit or cut-out. Alternatively, the bag 74 may be opened by pulling an appropriately positioned tear strip if one is provided as an integral part of the bag. Since the bag 74 can be placed into the container of the dispensing system in a seal state (i.e., the particulate material is fully sealed in the bag), the user does not have to wrestle with a heavy open bag to pour the contents into a container but rather has the far easier task of opening and emptying a bag which has already been positioned inside the container in a sealed state. This feature of the dispensing system of the current invention greatly simplifies the filling operation and avoids accidental spilling and clean-up.

iii) The next step of the method is to gradually remove the bag from the container 2 to empty its contents into the container. This is generally done by gradually shifting the position of the bag while it is being removed. After the bag 74 is emptied and removed from the container 2 of the dispensing system 1, the container 2 can be covered with the optional container cover 64 and pour spout cover 70.

iv) The final step of the process is to dispense the solid particulate material from the container 2 of the dispensing system 1 into any suitable container provided by the user that is suitable for transporting the solid material to the application site, e.g., a pail. Alternatively, the contents can be dispensed directly at the application site if the dispensing system 1 is co-located there, e.g., near a litter box. The solid particulate material is dispensed by disengaging the locking member (e.g., 50 or 48, thus placing the container 2 in a “rotation mode” and rotating the container (e.g., FIG. 2) in a controlled manner, generally by using the optional handle 72 provided so as to dispense the particulate material from the container 2 into the second “transport” container (not shown) provided by the user.

It should be understood, of course that the specific forms of the invention herein illustrated and described are intended to be representative only, as certain changes may be made therein without departing from the clear teachings of the disclosure. Accordingly, reference should be made to the following appended claims in determining the full scope of the invention.

What is claimed is:

1. A dispensing system for the transient storage and dispensing of solid particulate materials comprising: a container comprising front and back walls and two side walls, a bottom, a pour spout affixed to the front wall, a container support tube joined to the side walls of the container; a container support stand comprising a base affixed to two upright members adjacent to the side walls of the container; a support rod which passes through the bag support tube and rotatably connects the container to the upright members of the container support stand; and a locking member which when engaged prevents rotation of the container; wherein the container can rotate at least about 180 degrees from the vertical when the locking member is not engaged.

2. The dispensing container according to claim 1 wherein one or more of the front, back and side walls are inclined inwardly such the container is tapered towards its bottom.

3. The dispensing container according to claim 2 wherein at least the front and side walls are inwardly sloping.

4. The dispensing container according to claim 1 wherein the locking member comprises a locking tube which is fixed to both side walls of the container and a removable locking rod which passes through said locking tube and a channel in at least one of the upright members of the container support stand.

5. The dispensing container according to claim 4 wherein the locking rod is joined to the at least one upright member by a removable fastening means.

6. The dispensing container according to claim 1 wherein the container further comprises a concave surface at the interior junction of at least the front wall and the bottom of the container.

7. The dispensing container according to claim 6 wherein the concave element is an integral part of the interior of one or both the front wall and bottom of the container.

8. The dispensing container according to claim 6 wherein the concave element is a separate piece which spans the lower interior portion of the front wall and the interior portion of the bottom of the container and covers a junction line between the front wall and bottom of the container.

9. The dispensing container according to claim 1 further comprising a cover which covers an opening in a top of the container and optionally extends over the pour spout.

10. The dispensing container according to claim 9 wherein the cover further comprises a peripheral flange which mates with a rim extending around the perimeter of the open top of the container, said flange securing the cover to the container.

11. The dispensing container according to claim 1 further comprising a pour spout cover.

12. The dispensing container according to claim 11 wherein the pour spout cover is affixed either to a container cover or to one or more walls of the container by means of a hinge or hinges permitting the pour spout cover to open when the container is rotated and the solid particulate material is dispensed.

13. The dispensing container according to claim 1, wherein the container provides a capacity to store at least about 40 lbs of solid.

14. The dispensing container according to claim 1, wherein the container has a volume of at least about 35 cubic decimeters (about 9.2 gallons).

15. The use of the dispensing container according to claim 1 for the transient storage and dispensing of wood pellets and chips, rock salt, water softening agents, cat litter, bird seed, pet food or lawn and shrub maintenance agents.

16. A method for the transient storage and dispensing of solid particulate materials comprising the steps of:
i) placing a bag containing solid particulate material into the dispensing container described in claim 1 wherein the dispensing system is in a locked position; and wherein the bag rests against and is supported by the container support tube;
ii) creating an opening in the bag so placed in step i), said opening positioned near to a lower portion of the bag and being sufficiently large to allow the solid particulate material to flow out from the bag and into the container;
iii) gradually removing the bag from the container to empty its contents;
iv) disengaging the locking member and rotating the container to dispense the particulate material from the container into a second container provided by a user.
